(19) United States
(12) Patent Application Publication
(10) Pub. No.: US 2013/0132514 A1
(43) Pub. Date: May 23, 2013

(54) SYSTEM AND METHOD FOR PERMITTING TEMPORARY ACCESS TO ELECTRONIC BOOKS USING WIRELESS COMMUNICATION SYSTEM

(71) Applicant: Connect Link USA Corp., Sunnyvale, CA (US)

(72) Inventor: Akira MURAMATSU, Sunnyvale, CA (US)

(73) Assignee: CONNECT LINK USA CORP., Sunnyvale, CA (US)

(21) Appl. No.: 13/673,236

(22) Filed: Nov. 9, 2012

Related U.S. Application Data
(60) Provisional application No. 61/563,203, filed on Nov. 23, 2011.

(51) Int. Cl. H04L 29/08

(52) U.S. Cl. CPC H04L 67/32
USPC 709/217

(57) ABSTRACT

The present invention relates to systems and methods for permitting temporary access to electronic books. Electronic books to be shared are selected on a distributor terminal and read on a user terminal which is in an area reached by wireless communication from the distributor terminal. The list of electronic books is deleted from a user terminal when moved to an area unreached by wireless communication from a distributor terminal. In another embodiment, a list of electronic books disclosed by a distributor terminal is automatically sent to a database when the distributor terminal is in an area reached by wireless communication from a wireless communication base, and those lists are aggregated on the database to display a bestseller ranking on the distributor terminal and/or digital signage so that the distributor can read the electronic book selected from the bestseller ranking through the wireless communication base.

### BACKGROUND OF THE INVENTION

1. Field of the Invention

The present invention relates to systems and methods for permitting temporary access to electronic books using wireless communication system.

2. Description of the Related Art

In recent years, electronic books which can be read on the mobile terminals, etc. have been broadly distributed in place of paper books.

Most of the traditional paper books allow consumers to check the contents of books before purchasing in stores. Although there has been a system for allowing consumers to check the contents of electronic books before purchasing, such parts have been restricted to small portion. Moreover, the parts allowed to check by users have been storable in the terminals of users.

To solve the above problems, Japanese Patent Publication Number 2007-164726 discloses the invention wherein an owner of a book uploads the book to a book broadcasting site and allows users to check the contents on their terminals free of charge. In this case, saving and printing of the contents are not allowed. When users check the books free of charge, advertisement may be displayed on the user terminals so that the server can earn advertising revenue even if users do not purchase electronic books.

However, such system can always display the contents of books on the user terminals, and it is not necessary for users to purchase the books if users do not need to save or print the contents of books.

Therefore, the object of the present invention is to allow temporary access to electronic books on the user terminals and to stimulate purchasing interest of users for electronic books.

### SUMMARY OF THE INVENTION

The present invention that solves the above problems is a system for permitting temporary access to electronic books comprising, means for selecting an electronic book to be distributed on a distributor terminal which stores the electronic book by purchase from a distribution source, means for selecting an electronic book to be read from a list of electronic books which was distributed by a distributor terminal on a user terminal which is in an area reached by wireless communication from a distributor terminal, means for reading the selected electronic book on a user terminal, means for activating a specialized software and saving access history on a server when the selected electronic book is read, and means for deleting a list of electronic books from a user terminal when a user terminal is in an area unreached by wireless communication from a distributor terminal.

Namely, this system allows a distributor terminal which owns electronic books by purchase to temporarily distribute electronic books free of charge to user terminals which are in an area reached by wireless communication, such as to a distributor's friends' terminals.

In this way, it is possible to stimulate purchasing interest of users since users can temporarily check contents of electronic books just like paper books.

The above system for permitting temporary access to electronic books can also be applied for a virtual environment. For instance, a distributor who purchased an electronic book can allow members of a specific group on the internet to check the contents of the book.

Furthermore, the present invention that solves the above problems is a system for permitting temporary access to electronic books comprising, means for disclosing a list of electronic books on a distributor terminal which stores the electronic books by purchase from a distribution source, means for automatically sending the list of electronic books from the distributor terminal to a database when the distributor terminal is in an area reached by wireless communication from a predetermined wireless communication base, means for aggregating the lists of electronic books received from the distributor terminals and generating a bestseller ranking of the electronic books on the database, means for displaying the bestseller ranking on the distributor terminals and/or a digital signage placed at the wireless communication base, and means for reading the electronic books selected from the bestseller ranking on the distributor terminals through the wireless communication base within the restrictions set by a distribution source.

The possibility of information manipulation of a bestseller ranking issued by bookstores cannot be denied. According to the present invention, more reliable and live ranking can be provided by aggregating real-time data from people gathered at a specific public place, for example, rail and bus stations and event sites. The reality of such ranking raises value as information and it will bring more commercial opportunities.

### BRIEF DESCRIPTION OF THE DRAWINGS

For more complete understanding of the present invention and the advantages hereof, reference is now made to the following description taken in conjunction with the accompanying drawings wherein:

FIG. 1 depicts a structure of a system for permitting temporary access to electronic books according to a first embodiment of the present invention;

FIG. 2 depicts a flowchart of a process for permitting temporary access to electronic books according to a first embodiment of the present invention;

FIG. 3 depicts a structure of a system for permitting temporary access to electronic books according to a second embodiment of the present invention; and

FIG. 4 depicts a flowchart of a process for permitting temporary access to electronic books according to a second embodiment of the present invention.

### DETAILED DESCRIPTION OF THE EXEMPLARY EMBODIMENTS OF THE INVENTION

A description will be given below, of a system according to embodiments of the present invention with reference to the attached drawings.

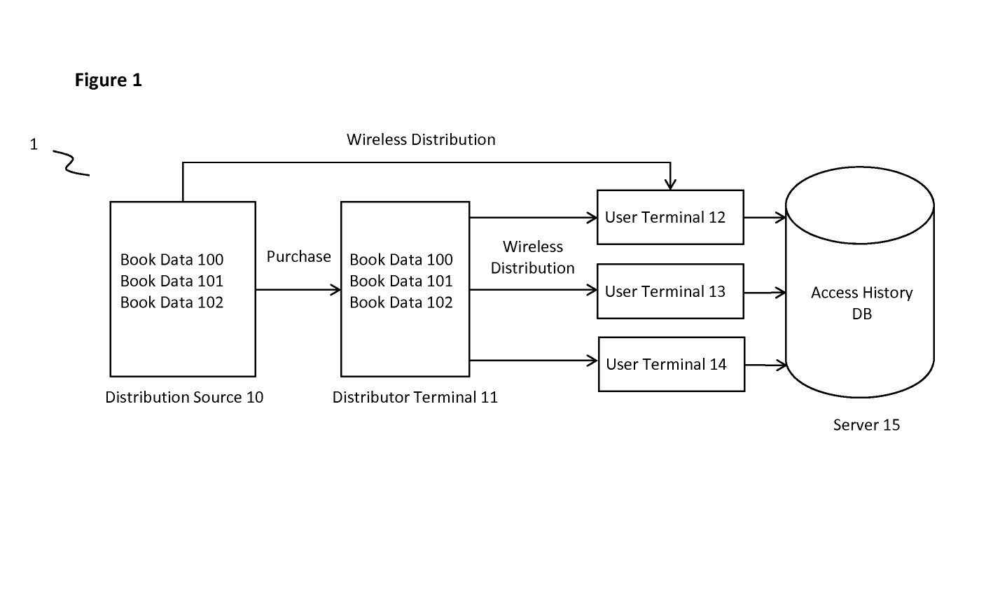

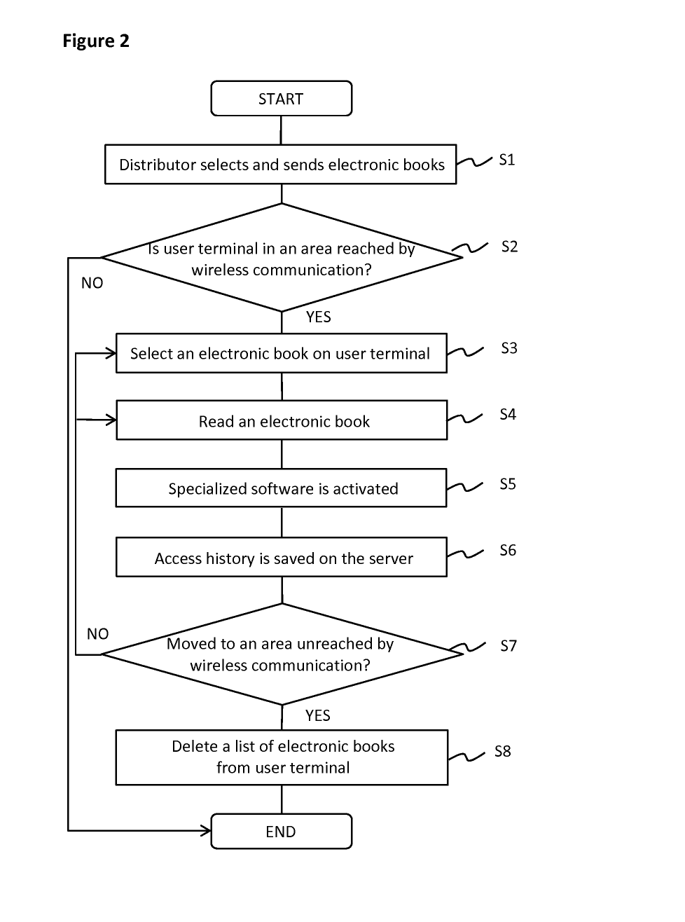

First, a description will be given, of a system for permitting temporary access to electronic books according to a first embodiment of the present invention with reference to FIGS. 1 and 2.

FIG. 1 shows a structure of a system for permitting temporary access to electronic books 1 and FIG. 2 shows a flowchart of the system of FIG. 1.

As shown in FIG. 1, the system for permitting temporary access to electronic books 1 according to a first embodiment of the present invention permits free distribution of electronic book data 100-102 from the distributor terminal 11 which stores electronic book data 100-102 by purchase from the distribution source 10 in advance to user terminals 12-14 which are in the range stably reached by wireless communication allowed as distribution means from the distributor terminal 11.

Furthermore, a distributor in this embodiment can be the distribution source 10 which sells electronic book data 100-102 and/or the distributor terminal 11 which stores electronic book data 100-102 by purchase. The term “terminal” in this specification includes, for example, processing device such as notebook computers, mobile phones, tablet computers, and PDAs.

According to the flowchart of a system for permitting temporary access to electronic books 1 shown in FIG. 2, a distributor selects and sends at least one book desired to be shared on the distributor terminal 11. And then, a list of distributed electronic book data is displayed on the user terminals 12-14 which are in the range stably reached by wireless communication from the distributor terminal 11, and users can arbitrarily select and read book data desired. When an electronic book is read on the user terminals 12-14, a specialized software is activated and access history of each user terminal is saved on the server 15. By saving such access history, book information, etc. which is appropriate for interest of each user can be sent to user terminals 12-14 and that can further stimulate purchasing interest of users for electronic books.

Then, the list of electronic book data distributed is deleted from the user terminals 12-14 and access to the electronic books will be invalid when the user terminals 12-14 are in an area unreachable by wireless communication from the distributor terminal 11. In the present invention, the electronic book data accessed by each user cannot be printed out or saved on the user terminals 12-14. Moreover, electronic book data which can be distributed free of charge by either the distribution source 10 or the distributor terminal 11 is arbitrarily decided based on agreement with owners of copyright.

A system for permitting temporary access to electronic books 1 of the present invention can also be applied to a virtual environment. For example, the distributor terminal 11 which stores electronic book data 100-102 by purchase can share the electronic book data 100-102 with the members of a specific group on the internet only when logged in. In this case, a time limit can be arbitrarily set.

In this way, electronic books can be easily shared just like paper books. In terms of paper books, it is like borrowing a book from a friend who bought the book or checking the contents of the book at a book store to decide whether or not to buy the book.

In this embodiment, three user terminals are presented relative to one distributor terminal, however, one can practice the present invention as long as there is at least one distributor terminal and at least one user terminal. Moreover, the number of user terminals can be arbitrarily restricted.

Furthermore, a system for permitting temporary access to electronic books 1 of the present invention can also be applied to handouts used in schools and offices. For instance, an instructor can easily display contents of a book to which he wants to make a reference on his student's terminals at his lecture without making his students buy the book. In addition, internal documents used at a meeting can be displayed on the terminals of participants only at the meeting that information security will be reinforced.

As explained above, the first embodiment of the present invention is supposed to be practiced by people who gather either in a physical or a virtual space having common values. In such case, distributed electronic book data can overlap if the present invention was practiced by multiple distributors in a specific space, for example, in a lecture meeting by the novelist Haruki Murakami. In this case, the list of distributed electronic book data can be ranked in descending order of distributed number and displayed on the user terminals which are in an area reached by wireless communication from the distributor terminals. In this way, users get to know which products are popular among people who have the same or similar interests as them and will be useful reference when considering purchase.

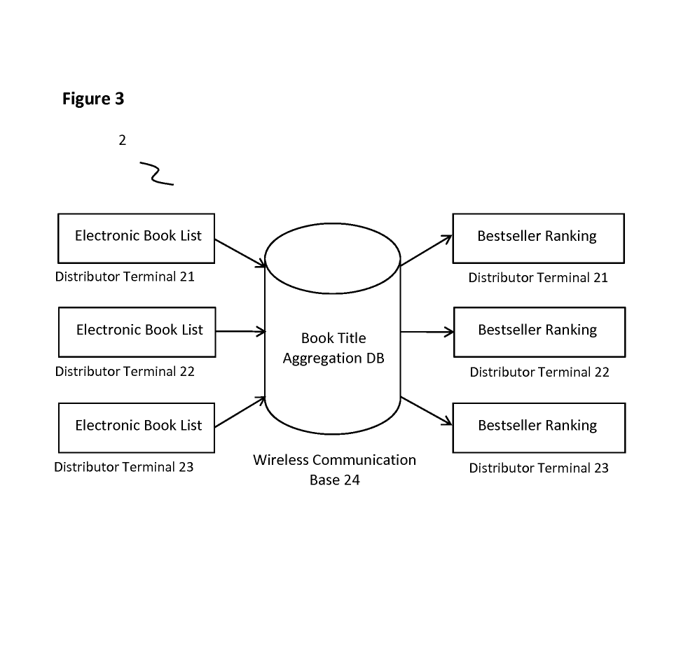

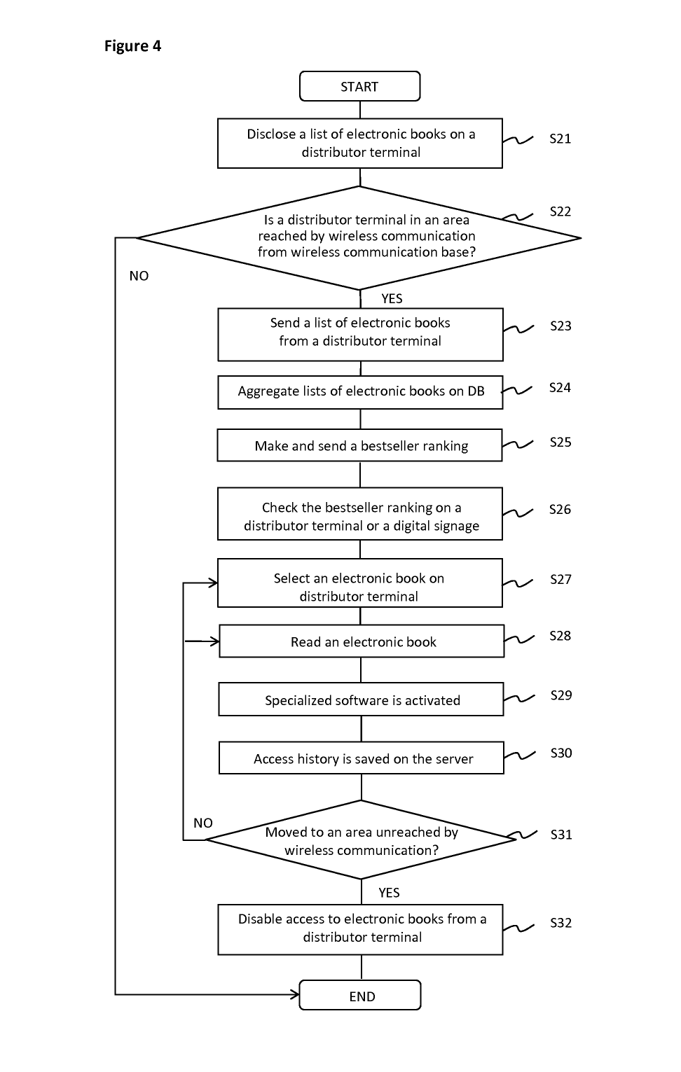

Secondly, a description will be given, of a system for permitting temporary access to electronic books according to a second embodiment of the present invention with reference to FIGS. 3 and 4.

FIG. 3 shows a structure of a system for permitting temporary access to electronic books 2 and FIG. 4 shows a flowchart of the system of FIG. 3.

As shown in FIG. 3, the system for permitting temporary access to electronic books 2 according to a second embodiment of the present invention aggregates lists of electronic books automatically distributed by the distributor terminals 21-23, makes a bestseller ranking and displays it on the distributor terminals 21-23, and arbitrarily permits free distribution of electronic books from the bestseller ranking on the distributor terminals 21-23 which are in the range stably reached by wireless communication from the wireless communication base 24.

According to the flowchart of a system for permitting temporary access to electronic books 2 shown in FIG. 4, distributors disclose lists of electronic books purchased from distribution sources on their terminals 21-23 beforehand. Then, the lists are automatically sent to the database of wireless communication base 24 placed in, for example, rail stations, bus terminals, airport, etc. when the distributor terminals are in the range stably reached by wireless communication from the wireless communication base 24.

The received lists of electronic books are aggregated on the database of the wireless communication base 24, and a bestseller ranking is generated. This bestseller ranking can be sorted according to, for example, weekly, monthly, real-time, etc. and can also be displayed by category such as general, comics, business, and science. These rankings are automatically sent to the distributor terminals 21-23. These rankings can also be displayed on the digital signage placed at the wireless communication base 24. This will allow a distributor to configure the settings for disclosing the list of electronic books on his terminal to receive the same rankings on his terminal after finding the digital signage even if the distributor had not disclosed his list in advance. Moreover, distributor terminals which have configured the settings for disclosing the list of electronic books can receive the rankings even if the terminals virtually do not own lists of electronic books for disclosure.

Then, electronic books can be arbitrarily selected from the displayed bestseller rankings and read on the distributor terminals 21-23 through the wireless communication base within the restrictions set by distribution sources as it is for the first embodiment of the present invention. When an electronic book is read on the distributor terminals 21-23, specialized software is activated and access history of each distributor terminal is saved on the server. The access to the electronic books will be invalid when the distributor terminals 21-23 are in the area unreachable by wireless communication from the wireless communication base 24. However, the bestseller rankings can be saved on the distributor terminals 21-23 for later reference.

The numbers of distributor terminals are 21-23 for this particular embodiment, however, the numbers of distributor terminals are not specifically restricted. Furthermore, a wireless communication base is not necessarily placed in one spot. For instance, it can be placed in each store in a shopping street so that wireless communication can cover a broad area like a shopping street.

Moreover, the settings for affiliate program can be configured in the second embodiment of the present invention. The places which provide wireless communication bases such as stations can get compensation from distribution sources of electronic books such as publishers. Compensation does not need to be money, but also electronic money. Some advantages can be brought to a wireless communication base when an electronic book is purchased on a distributor terminal via the bestseller rankings of the wireless communication base.

From the aforementioned explanation, those skilled in the art ascertain the essential characteristics of the present invention and can make the various modifications and variations to the present invention to adapt it to various usages and conditions without departing from the spirit and scope of the claims. For instance, the present invention can be applied for music data and visual data, not limiting to electronic books.

What is claimed is:

1. A system for permitting temporary access to electronic books comprising: means for selecting an electronic book to be distributed on a distributor terminal which stores the electronic book by purchase from a distribution source; means for selecting an electronic book to be read from a list of electronic books which was distributed by a distributor terminal on a user terminal which is in an area reached by wireless communication from a distributor terminal; means for reading the selected electronic book on a user terminal; means for activating a specialized software and saving access history on a server when the selected electronic book is read; and means for deleting a list of electronic books from a user terminal when a user terminal is in an area unreached by wireless communication from a distributor terminal.

2. A system for permitting temporary access to electronic books as recited in claim 1 further comprising means for displaying a list of electronic books on user terminals which are in an area reached by wireless communication from a plurality of distributor terminals in descending order of distributed number of electronic books.

3. A system for permitting temporary access to electronic books comprising: means for disclosing a list of electronic books on a distributor terminal which stores the electronic books by purchase from a distribution source; means for automatically sending the list of electronic books from the distributor terminal to a database when the distributor terminal is in an area reached by wireless communication from a predetermined wireless communication base; means for aggregating the lists of electronic books received from the distributor terminals and generating a bestseller ranking of the electronic books on the database; means for displaying the bestseller ranking on the distributor terminals and/or a digital signage placed at the wireless communication base; and means for reading the electronic books selected from the bestseller ranking on the distributor terminals through the wireless communication base within the restrictions set by a distribution source.

4. A system for permitting temporary access to electronic books as recited in claim 3 further comprising means for configuring the settings for an affiliate program which brings the wireless communication base compensation when an electronic book is purchased via the bestseller ranking displayed on the distributor terminals.

5. A method of permitting temporary access to electronic books comprising the steps: selecting an electronic book to be distributed on a distributor terminal which stores the electronic book by purchase from a distribution source; selecting an electronic book to be read from a list of electronic books which was distributed by a distributor terminal on a user terminal which is in an area reached by wireless communication from a distributor terminal; reading the selected electronic book on a user terminal; activating a specialized software and saving access history on a server when the selected electronic book is read; and deleting a list of electronic books from a user terminal when a user terminal is in an area unreached by wireless communication from a distributor terminal.

6. A method of permitting temporary access to electronic books as recited in claim 5 further comprising the step of displaying a list of electronic books on user terminals which are in an area reached by wireless communication from a plurality of distributor terminals in descending order of distributed number of electronic books.

7. A method of permitting temporary access to electronic books comprising the steps: disclosing a list of electronic books on a distributor terminal which stores the electronic books by purchase from a distribution source; automatically sending the list of electronic books from the distributor terminal to a database when the distributor terminal is in an area reached by wireless communication from a predetermined wireless communication base; aggregating the lists of electronic books received from the distributor terminals and generating a bestseller ranking of the electronic books on the database; displaying the bestseller ranking on the distributor terminals and/or a digital signage placed at the wireless communication base; and reading the electronic books selected from the bestseller ranking on the distributor terminals through the wireless communication base within the restrictions set by a distribution source.

8. A method of permitting temporary access to electronic books as recited in claim 7 further comprising the step of configuring the settings for an affiliate program which brings the wireless communication base compensation when an electronic book is purchased via the bestseller ranking displayed on the distributor terminals.
